(19) United States
(12) Patent Application Publication
(10) Pub. No.: US 2021/0046619 A1
(43) Pub. Date: Feb. 18, 2021

(54) Hex Nut and Bolt Positioner

(71) Applicant: Zoltan Nemeth, Moultonborough, NH (US)

(72) Inventor: Zoltan Nemeth, Moultonborough, NH (US)

(21) Appl. No.: 16/539,326

(22) Filed: Aug. 13, 2019

(51) Int. Cl. B25B 13/48; B25B 23/16

(52) U.S. Cl. CPC B25B 13/481; B25B 23/16

(57) ABSTRACT

The Hex Nut and Bolt Positioner is a size-specific tool which enables the user to securely position a hex-head fastener into a hard-to-reach location, so the threads can be started. After the threads are securely engaged the wrench can be easily unlocked from the fastener and removed from the tight work space. The tool can also be used to remove already loosened fasteners without the risk of dropping them into the equipment.

### BRIEF DESCRIPTION OF SEVERAL VIEWS OF THE DRAWING

FIG. 1 is a perspective view of the complete Hex Nut and Bolt Positioner in the open/unlocked position.

FIG. 2 is an exploded view showing all of the parts of the Positioner, suggesting the order of assembly.

FIG. 3 shows the complete Positioner in the unlocked/open state.

FIG. 4 shows the complete Positioner in the locked/closed state.

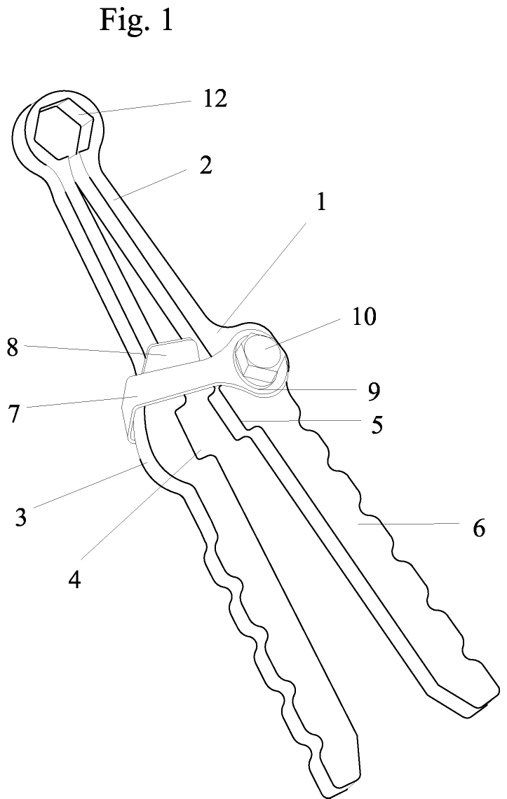

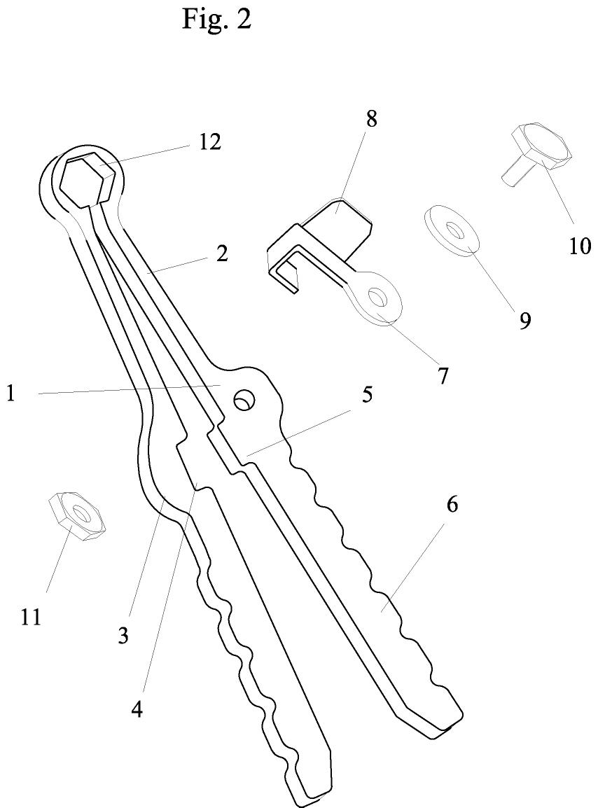

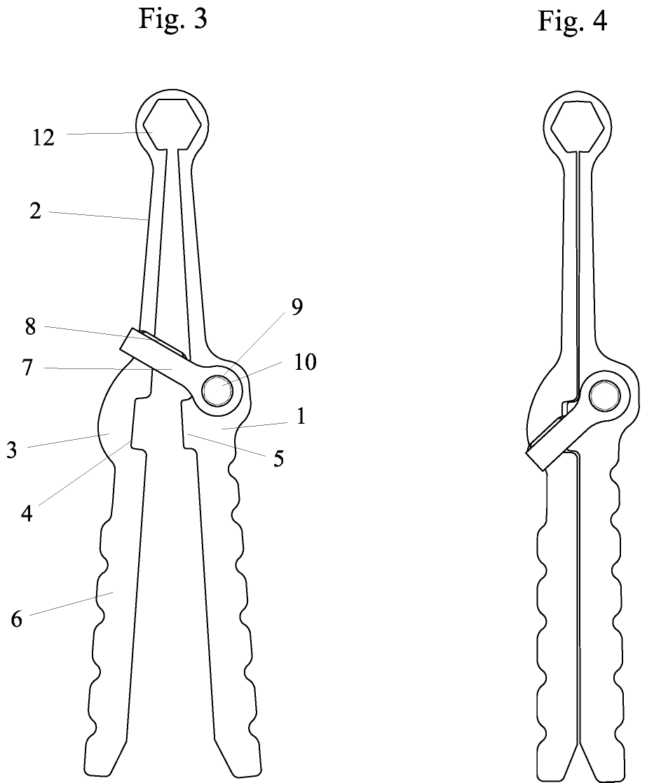

### DETAILED DESCRIPTION OF THE INVENTION

A key and unmatched feature of the Hex Nut and Bolt Positioner is, that it fits into tighter spaces than even an ordinary box-wrench would fit, therefore it is easier to operate and more practical than other patents reviewed by the inventor in the preliminary search. It holds fasteners at least as securely as any prior, or current competing inventions. The operator has complete control of the fastener after it has been locked. No sliding, or pivoting occurs due to loose grip. The Hex-chuck end of the tool is slightly (approximately 10 degrees) bent up. This offset angle provides room for fingers holding the tool to better permit the user in lining up the fastener before catching the threads. Due to the lack of availability of a practical hex positioner tool on the market most shops typically use unsuitable tools for this role. Many tools, such as vise grips are likely to damage the surfaces of fasteners. In contrast the forces to operate this tool are far lighter than the tightening of a vise-grip, or plyers. This invention grips the fastener all around instead of concentrating the holding forces in a few spots. When plyers, or vise-grips are used the fasteners often pivot, loosen up and snap out of the tool. The operation of the device starts with picking up the nut from a flat surface, or inserting the bolt head into the Hex-chuck 12. Once the fastener's head is flush with the surface of the tool, the Handle 6 can be lightly squeezed by two fingers. This secures the fastener in the tool by contracting the size of the chuck. While the handles are squeezed the Latch 7 can be pulled into the locked position by sliding the Tab 8 with the thumb toward the operator. This is a very intuitive, effortless one-handed process, the forces exerted on the tool's Handle 6 and Latch 7 are very light. After locking takes place the Handle 6 and the Latch 7 both can be released. The handle will move back a very small amount against the Latch 7. The fastener can now be freely manipulated and installed into the desired position. Once the threads have started, start removing the Positioner by lightly squeezing the Handle 6. This gets the Latch 7 loose, so the Tab 8 can be effortlessly pushed away to unlock the tool. At this point relax the squeeze on the Handles 6 and the Handles 6 and Arms 2 automatically spring open, the Hex-chuck 12 expands in size and the Positioner can be removed. The fasteners can be tightened up using ordinary shop tools. The Positioner is size specific, meaning that each hex-head size needs an individual tool made for that particular size. Some SAE and Metric prototypes have been made, tested and successfully used during development of this invention. Due to varying tolerances in fastener manufacturing, wear and prior damage to the fasteners the dimensions of the Hex-chuck 12 is sized for the largest possible hex dimensions for that particular size. When such an oversized hex-head is inserted into the tool and locked, the Arms 2 will bend to absorb the tension and prevent damage to the Positioner and the fastener. The tool can also be used to remove already loosened fasteners from tight spaces. It is placed onto the head of the fastener and locked. Once the threads are disengaged the fastener can be removed from the work space and then unlocked/removed from the tool. The Positioner is not a substitute for a wrench, so it is not intended to be used to tighten, or loosen fasteners, but it will withstand a certain amount of torque. In the locked position of the tool Gap 4 and Tooth 5 are engaged to prevent sliding of the Handles 6 and the Arms 2. This will assist in directing any excessive torque into the locked axis of the Handles 6 and Arms 2, instead of stressing and distorting the Hex-chuck 12. The Main body 1 and the Latch 7 can be produced by either CNC plasma cutting, or by fiber laser equipment. The prototypes have been plasma cut. Post processing consists of surface cleaning, deburring, filing and finishing, drilling, tapping and bending (of the Latch 7). The Latch 7 is bent around the Cam 3 in such a way that it keeps the two Handles 6 in line. It also prevents the inadvertent excessive opening of the arms, which could cause permanent damage to the tool. The Washer 9, Bolt 10 and Nut 11 form the hinge for the Latch 7 to rotate around.

What is claimed and sought to be secured as a United States utility patent is:

1. A Hex Nut and Bolt Positioner is a size-specific tool, which consists of a sheet metal Main body, a sheet metal Latch, with a Nut, Bolt and Washer to keep the assembly together and serve as pivot point for the Latch.

2. The Main body of claim 1 is a one piece sheet metal part, which has several distinct sections to perform as many distinct functions, such as a size-specific Hex-chuck section, thin enough that it flexes to tighten and loosen and this section is bent upward approximately 10 degrees, two narrow Arms extending from the Hex-chuck section, which are designed to be thin enough, so that they will bend in case an oversized object is locked into the tool, a Cam section, to enable the Latch to lock the tool on a nut, or bolt head, a Tooth and a Gap section to lock together when the tool is locked and two serrated Handles.

3. The design of Main body and Latch of claim 1 can easily be up, or down scaled using an appropriate CNC program for a suitable CNC Plasma Cutter, or CNC Fiber Laser machine to produce Positioners for any common nut and bolt size, SAE, or Metric.
